(19) United States
(12) Patent Application Publication
(10) Pub. No.: US 2014/0181963 A1
(43) Pub. Date: Jun. 26, 2014

(54) ELECTRONIC DEVICE AND FILE PROTECTION METHOD

(71) Applicants: HON HAI PRECISION INDUSTRY CO., LTD., New Taipei (TW); Hong Fu Jin Precision Industry (ShenZhen) Co., Ltd, Shenzhen (CN)

(72) Inventor: XIN GUO, Shenzhen (CN)

(73) Assignees: HON HAI PRECISION INDUSTRY CO., LTD., New Taipei (TW); Hong Fu Jin Precision Industry (ShenZhen) Co., Ltd, Shenzhen (CN)

(21) Appl. No.: 14/135,694

(22) Filed: Dec. 20, 2013

(30) Foreign Application Priority Data
Dec. 25, 2012 (CN) 2012105721430

(51) Int. Cl. G06F 21/32

(52) U.S. Cl. CPC G06F 21/32
USPC 726/19

(57) ABSTRACT

In a file protection method, when a request for opening a protected file is received, an environment image is captured, and character features in the environment image are extracted. The extracted character features are compared with character features of one or more authorized users that are pre-stored in a storage device, to determine if the environment image contains character features that match with the pre-stored character features of an authorized user. The content of the file is shown on the display device when the environment image contains character features that match with the pre-stored character features of an authorized user, and the file is forbidden to open when the environment image does not contain character features that match with the pre-stored character.

### BACKGROUND

1. Technical Field

Embodiments of the present disclosure relate to computer information security, and more particularly, to an electronic device and a file protection method.

2. Description of Related Art

Increasing demands upon corporate bodies to tighten up controls over who can access sensitive data has created a growing need for tools for this purpose. Today, there are a variety of technologies to help achieve this, some from the various creators of computer operating systems, and others from independent, enterprise solution providers. Currently, however, there are few specifically designed software solutions for preventing access by some users to sensitive files, while allowing access by others to these same files.

Therefore, there is a need to provide a system to solve the problem of preventing access by some users to sensitive files, while allowing access by others.

### BRIEF DESCRIPTION OF THE DRAWINGS

FIG. 1 is a block diagram of one embodiment of an electronic device with a file protection system installed.

FIG. 2 is a block diagram of one embodiment of function modules of the file protection system.

FIG. 3 is a flowchart of one embodiment of a file protection method.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

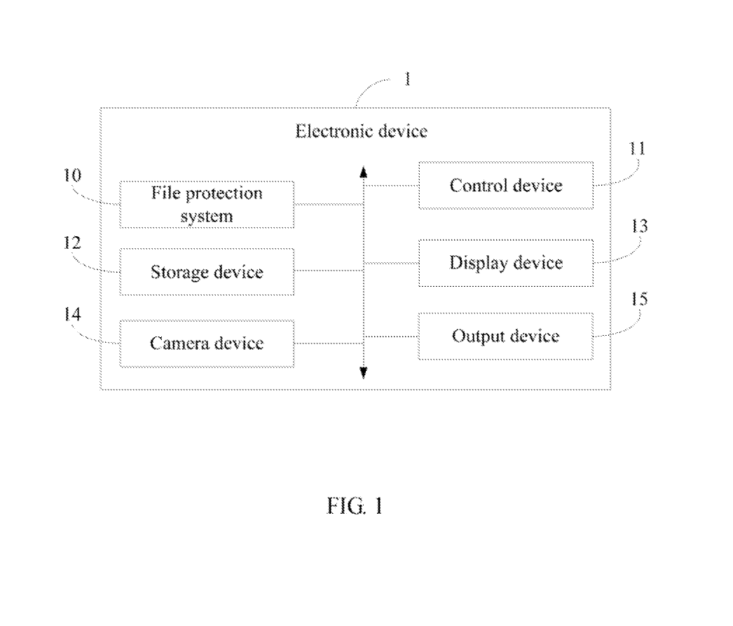

FIG. 1 is a block diagram of one embodiment of an electronic device 1 with a file protection system 10 installed. The electronic device 1 may be a smart phone, a computer, a personal digital assistant (PDA), for example. The electronic device 1 may further include a control device 11, a storage device 12, a display device 13, a camera device 14, and an output device 15. One skilled in the art would recognize that the electronic device 1 may be configured in a number of other ways and may include other or different components.

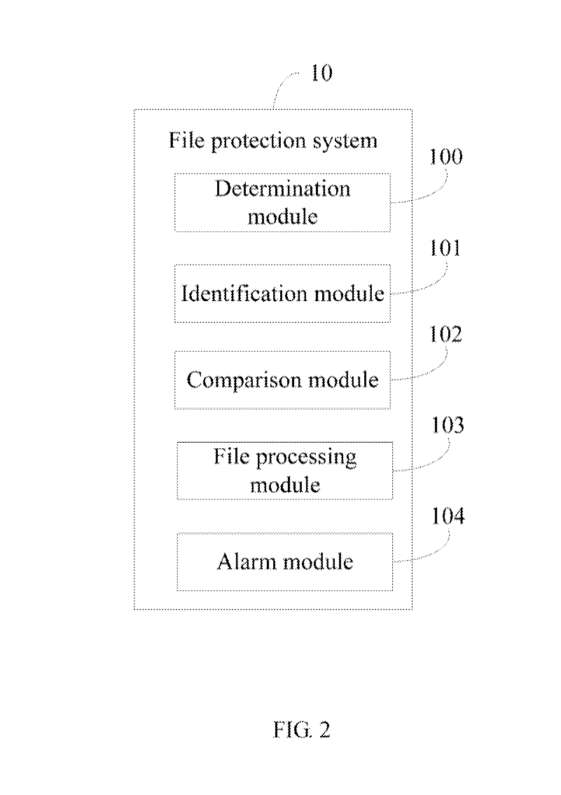

The file protection system 10 includes computerized codes in the form of one or more programs, which are stored in the storage device 12. In present embodiment, the one or more programs of the file protection system 10 are described in the form of function modules (see FIG. 2), which have functions of preventing access by some users to sensitive files, while allowing access by others to these same files, when executed by the control device 11.

The control device 11 may be a processor, a microprocessor, an application-specific integrated circuit (ASIC), and a field programmable gate array (FPGA), for example.

The storage device 12 may include some type(s) of non-transitory computer-readable storage mediums, such as a hard disk drive, a compact disc, a digital video disc, or a tape drive.

The display device 13 may be a screen of the electronic device 1 which display visible data that are generated or used by the file protection system 10.

The camera device 14 can be internal or external to the electronic device 1.

The output device 15 may be a light emitting diode (LED) or a buzzer.

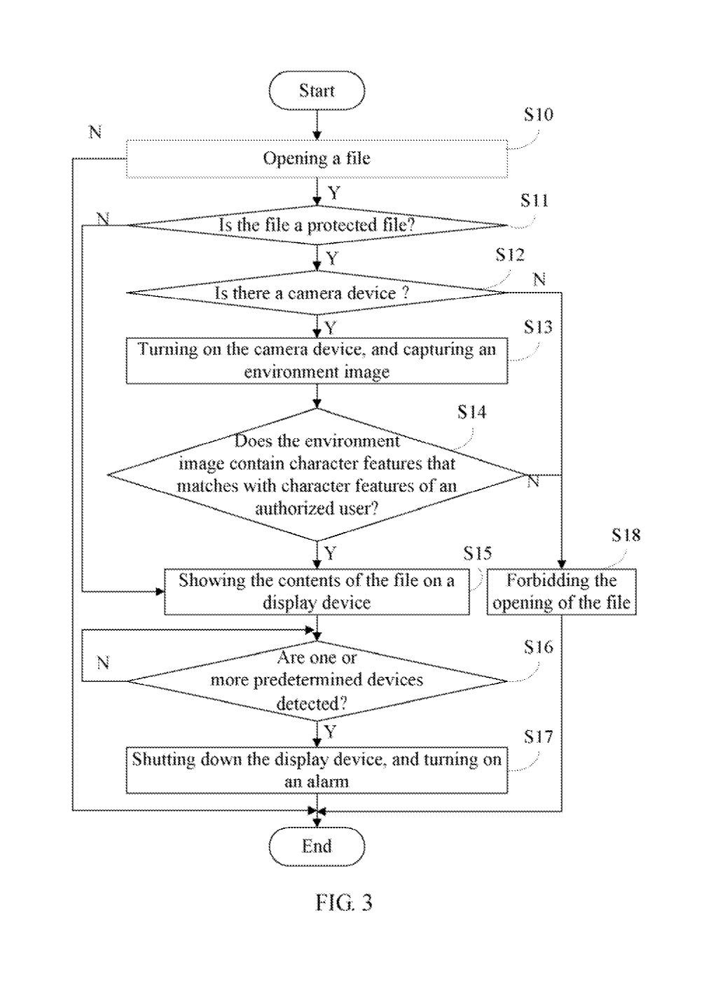

FIG. 2 is a block diagram of one embodiment of function modules of the file protection system 10. In one embodiment, the function modules comprise a determination module 100, an identification module 101, a comparison module 102, a file processing module 103, and an alarm module 104. Details of the functions of the function modules 100-104 are described with reference to FIG. 3.

FIG. 3 is a flowchart of one embodiment of a file protection method. The method is executed by the control device 11 of the electronic device 1. Depending on the embodiment, additional steps in FIG. 3 may be added, others removed, and the ordering of the steps may be changed.

In step S10, a file stored in the storage device 12 is opened.

In step S11, the determination module 100 determines if the file is a protected file. In one embodiment, each file stored in the storage device 12 comprises an attribute tag which indicates if a file is a protected file. When the file is a protected file, step S12 is implemented. Otherwise, when the file is not a protected file, step S15 is implemented.

In step S12, the identification module 101 identifies if there is a camera device 14 internally or externally in the electronic device 1. The identification module 101 searches hardware information of the electronic device 1 to indentify if there is a camera device 14 attached or connected internally or externally to the electronic device 1. When there is a camera device 14 attached or connected internally or externally in the electronic device 1, step S13 is implemented. Otherwise, when there is no camera device 14 internally or externally in the electronic device 1, step S18 is implemented to forbid the opening of the file.

In step S13, the identification module 101 turns on the camera device 14, and captures an environment image of the electronic device 1 using the camera device 14.

In step S14, the comparison module 102 extract character features in the environment image, and compares the extracted character features with character features of one or more authorized users that are pre-stored in the storage device 12, to determine if the environment image contains character features that matches with the pre-stored character features of an authorized user. In one embodiment, the character features may comprise face feature for example. When the environment image contains character features matching the pre-stored character features of an authorized user, step S15 is implemented. Otherwise, when the environment image does not contain character features matching the pre-stored character features of an authorized user, step S18 is implemented to forbid the opening of the file.

In step S15, the file processing module 103 shows the contents of the file on the display device 13.

In step S16, the alarm module 104 determines if one or more predetermined devices are detected surrounding the electronic device 1 according to environment images captured by the camera device 14 at predetermined period. In one embodiment, the predetermined devices may comprise a camera, or a smart phone, for example, which can take images of the file. When one or more predetermined devices are detected, step S17 is implemented.

In step S17, the alarm module 104 shuts down the display device 13, and controls the output device 15 to turn on an alarm.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device, comprising:
a storage device stores a plurality of files;
at least one processor; and
one or more modules that are stored in the storage device and executed by the at least one processor, the one or more modules comprising instructions to:
determine whether a file is a protected file when a request of opening the file is received;
turn on a camera device of the electronic device, and capture an environment image of the electronic device using the camera device;
extract character features in the environment image, compare the extracted character features with character features of one or more authorized users that are pre-stored in the storage device, and determine whether the environment image contains character features that matches with the pre-stored character features of an authorized user; and
show the contents of the file on a display device when the environment image contains character features that matches with the pre-stored character features of an authorized user, and forbid the opening of the file when the environment image does not contain character features that matches with the pre-stored character features of an authorized user.

2. The electronic device according to claim 1, wherein each file stored in the storage device comprises an attribute tag which indicates whether the file is a protected file.

3. The electronic device according to claim 1, wherein the camera device is internal or external to the electronic device.

4. The electronic device according to claim 3, wherein the one or more modules further comprising instructions to:
forbid the opening of the file when there is no camera device in the electronic device.

5. The electronic device according to claim 1, wherein the character features comprise face features, and fingerprint feature.

6. The electronic device according to claim 1, wherein the one or more modules further comprising instructions to:
shut down the display device and control an output device to turn on an alarm when one or more predetermined devices around the electronic device are detected according to environment images captured by the camera device at a predetermined period.

7. The electronic device according to claim 6, wherein the predetermined devices comprise a camera, and a smart phone which is capable of taking images of the file.

8. A file protection method implemented by an electronic device, comprising:
determining whether a file is a protected file when a request of opening the file is received;
turning on a camera device of the electronic device, and capturing an environment image of the electronic device using the camera device when the file is a protected file;
extracting character features in the environment image, comparing the extracted character features with character features of one or more authorized users that are pre-stored in a storage device, and determining whether the environment image contains character features that matches with the pre-stored character features of an authorized user; and
showing the contents of the file on a display device when the environment image contains character features that matches with the pre-stored character features of an authorized user, and forbidding the opening of the file when the environment image does not contain character features that matches with the pre-stored character features of an authorized user.

9. The method according to claim 8, wherein each file stored in the storage device comprises an attribute tag which indicates whether the file is a protected file.

10. The method according to claim 8, further comprising:
forbidding the opening of the file when there is no camera device in the electronic device.

11. The method according to claim 8, wherein the character features comprise face features, and fingerprint feature.

12. The method according to claim 8, further comprising:
shutting down the display device and controlling an output device to turn on an alarm when one or more predetermined devices around the electronic device are detected according to environment images captured by the camera device at a predetermined period.

13. The method according to claim 12, wherein the predetermined devices comprise a camera, and a smart phone which is capable of taking images of the file.

14. A non-transitory storage medium having stored thereon instructions that, when executed by processers of an electronic device, causes the processers to perform a file protection method, wherein the method comprises:
determining whether a file is a protected file when a request of opening the file is received;
turning on a camera device of the electronic device, and capturing an environment image of the electronic device using the camera device when the file is a protected file;
extracting character features in the environment image, comparing the extracted character features with character features of one or more authorized users that are pre-stored in a storage device, and determining whether the environment image contains character features that matches with the pre-stored character features of an authorized user; and
showing the contents of the file on a display device when the environment image contains character features that matches with the pre-stored character features of an authorized user, and forbidding the opening of the open the file when the environment image does not contain character features that matches with the pre-stored character.

15. The non-transitory storage medium according to claim 14, wherein each file stored in the storage device comprises an attribute tag which indicates whether the file is a protected file.

16. The non-transitory storage medium according to claim 14, wherein the method further comprises:
forbidding the opening of the file when there is no camera device in the electronic device.

17. The non-transitory storage medium according to claim 14, wherein the character features comprise face features, and fingerprint feature.

18. The non-transitory storage medium according to claim 14, wherein the method further comprises:
shutting down the display device and controlling an output device to turn on an alarm when one or more predetermined devices around the electronic device are detected according to environment images captured by the camera device at a predetermined period.

19. The non-transitory storage medium according to claim 18, wherein the predetermined devices comprise a camera, and a smart phone which is capable of taking images of the file.
